(19) United States
(12) Patent Application Publication
(10) Pub. No.: US 2009/0284470 A1
(43) Pub. Date: Nov. 19, 2009

(54) COMPUTER SYSTEM WITH MOUSE

(75) Inventor: JEN-YEE LIU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/178,653

(22) Filed: Jul. 24, 2008

(30) Foreign Application Priority Data
May 16, 2008 (CN) 200810301597.8

(51) Int. Cl. G06F 3/033

(52) U.S. Cl. 345/163

(57) ABSTRACT

An exemplary computer system includes a host computer and a mouse. The host computer comprises vertical and horizontal scrolling drivers. The mouse includes a scroll wheel, a sensor and a switch connected in series. The scroll wheel generates signals corresponding to navigation commands. The sensor senses the signals, and converts the signals to a format suitable for the vertical and horizontal scrolling drivers. The switch is connected to the vertical and horizontal scrolling drivers selectively. The vertical or horizontal scrolling drivers which is connected to the switch enables navigating in vertical or horizontal directions according to the generated signals respectively.

### BACKGROUND

1. Field of the Invention

The present invention relates to a computer mouse.

2. Description of the Related Art

Scroll wheels have been provided on computer mice and used by computer operators for various functions such as navigating an image on a display. Typically, navigation only includes vertically scrolling through an image by rotating the scroll wheel. However, if you want to horizontally scroll through an image that may require additional wheels, which can be more expensive in manufacturing.

What is needed, therefore, is to provide a mouse which can navigate an image on a screen both vertically and horizontally with one scroll wheel.

### BRIEF DESCRIPTION OF THE DRAWINGS

FIG. 1 is a block diagram of a mouse and computer system including a mouse according to an exemplary embodiment of the present invention; and

FIG. 2 is a schematic view of the mouse in FIG. 1.

### DETAILED DESCRIPTION

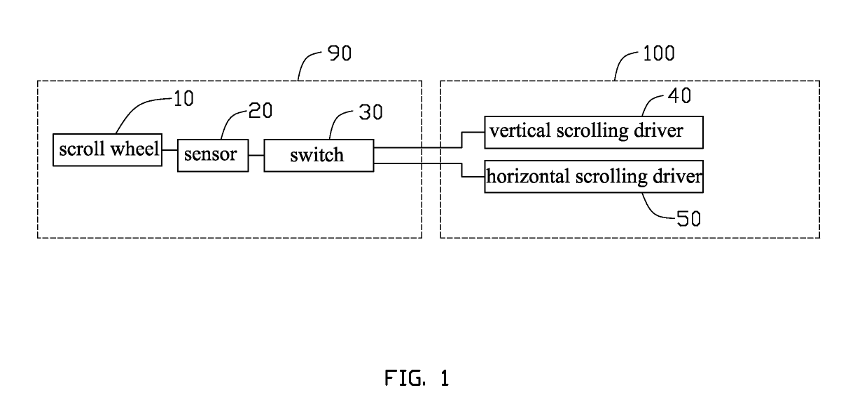

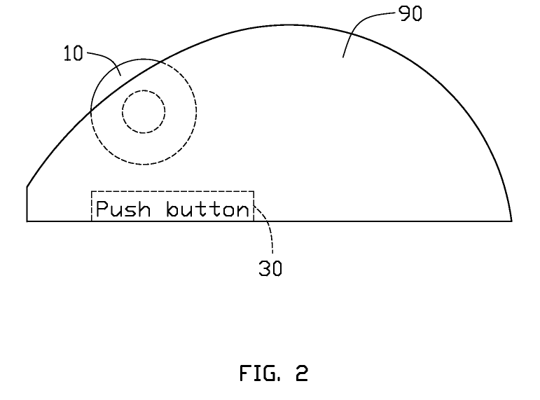

Referring to FIGS. 1 and 2, a computer system in accordance with an embodiment of the present invention includes a mouse 90 and a host computer 100. The mouse 90 includes a scroll wheel 10, a sensor 20 and a switch 30 connected in series. The host computer 100 includes a vertical scrolling driver 40 and a horizontal scrolling driver 50. The switch 30 is connected to vertical or horizontal scrolling drivers 40 or 50 selectively.

In this embodiment, the scroll wheel 10 is rotatable to generate signals corresponding to navigation commands from a user viewing an image on a display of the computer 100. The sensor 20 receives and converts the signals to a format suitable for the vertical and horizontal scrolling drivers 40, 50. The switch 30 is a push button located under the scroll wheel 10 in the mouse 90.

In use, in this embodiment, the switch 30 can control which one of the vertical and horizontal scrolling drivers 40 or 50 should be used. Herein we assume the switch 30 defaults to using the vertical scrolling driver 40 and the operation of the scroll wheel 10 allows vertical navigation of images on the display. To change scroll function to allow horizontal navigation a user simply presses down on the scroll wheel 10 once, causing the button of the switch 30 to be depressed to switch from the vertical scrolling driver 40 to the horizontal scrolling driver 50. To change back to vertical scrolling the user just presses down on the scroll wheel 10 again to switch back to the vertical scrolling driver 40.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A computer system comprising:
a host computer comprising a vertical scrolling driver and a horizontal scrolling driver; and
a mouse comprising:
a scroll wheel capable of generating signals corresponding to navigation commands;
a sensor capable of sensing the signals, and converting the signals to a format suitable for the vertical and horizontal scrolling drivers;
a switch connected to the sensor, the switch being connected to, and capable of selectively controlling the use of, one of the vertical or the horizontal scrolling drivers;
wherein when the switch is connected to the vertical scrolling driver, the vertical scrolling driver is capable of enabling navigating in vertical direction according to the generated signals; and when the switch is connected to the vertical scrolling driver, the horizontal scrolling driver is capable of enabling navigating in horizontal direction according to the generated signals.

2. The computer system as claimed in claim 1, wherein the switch is a push button located under the scroll wheel in the mouse, the switch button is controlled by pressing down on the scroll wheel.

3. A method for navigating on a display of a computer system comprising:
providing a host computer comprising:
a vertical scrolling driver and a horizontal scrolling driver; and
a mouse comprising a scroll wheel, a sensor and a switch connected in series;
completing selection of use of one of the vertical or horizontal scrolling drivers via the switch;
generating signals corresponding to navigation commands by the scroll wheel;
sensing the generated signals and converting the generated signals to a format suitable for the vertical and horizontal scrolling drivers by the sensor;
navigating in a corresponding direction by the vertical or horizontal scrolling drivers which is connected to the switch according to the generated signals.

4. The method as claimed in claim 3, wherein the switch is located under the scroll wheel in the mouse.

5. The method as claimed in claim 4, wherein the switch is a push button.

6. The method as claimed in claim 5, wherein the completing step comprises pressing down on the scroll wheel to control the switch button to select one of the drivers.

7. The method as claimed in claim 6, wherein when the scroll wheel is pressed down again, the switch selects the other driver.

8. The method as claimed in claim 3, wherein the generating step comprises rotating the scroll wheel.

9. A mouse device for a computer having a vertical scrolling driver and a horizontal scrolling driver, the mouse device comprising:
a scroll wheel capable of generating signals corresponding to navigation commands;
a sensor capable of sensing the signals, and converting the signals to a format suitable for the vertical and horizontal scrolling drivers;
a switch connected to the sensor, the switch being connected to, and capable of selectively controlling the use of, one of the vertical or the horizontal scrolling drivers;
wherein when the switch is connected to the vertical scrolling driver, the vertical scrolling driver is capable of enabling navigating in vertical direction according to the generated signals; and when the switch is connected to the horizontal scrolling driver, the horizontal scrolling driver is capable of enabling navigating in horizontal direction according to the generated signals.
